(19) United States
(12) Patent Application Publication
(10) Pub. No.: US 2026/0276029 A1
(43) Pub. Date: Sep. 17, 2026

(54) T-Bolt Fastening System

(71) Applicant: Allfasteners USA, LLC, Medina, OH (US)

(72) Inventors: Bruce A. Carmichael, Hinckley, OH (US); Michael Strange, Columbia Station, OH (US); Eli Clark, Fairlawn, OH (US); Brandon Knapp, New London, OH (US)

(73) Assignee: Allfasteners USA, LLC, Medina, OH (US)

(21) Appl. No.: 19/669,051

(22) Filed: May 6, 2026

Related U.S. Application Data
(63) Continuation-in-part of application No. 18/798,902, filed on Aug. 9, 2024.

(51) Int. Cl. F16B 39/282; F16B 5/02; F16B 43/00

(52) U.S. Cl. CPC F16B 39/282; F16B 5/02; F16B 43/00

(57) ABSTRACT

A fastening system includes a T-bolt, a nut, and a washer. The T-bolt has a bolt head base portion with an interior end having a bolt head collar portion extending from the interior end of the bolt head base portion. The washer includes a washer base portion that includes an interior end having a washer engaging surface with the washer engaging surface including a plurality of concentric rings disposed around an aperture of the washer. When the fastening system is in an installed position for fastening two joining members together, the interior end of the bolt head base portion of the T-bolt engages an outer surface of the first joining member, the bolt head collar portion extends at least partially into an opening formed by aligned first and second slots of the joining members, and the washer engaging surface engages an outer surface of the second joining member.

### CROSS REFERENCE TO RELATED APPLICATION

This application claims priority as a continuation-in-part to co-pending U.S. application Ser. No. 18/798,902 filed Aug. 9, 2024, entitled “T-Bolt Fastening System,” the entire contents of which are incorporated herein by reference.

### FIELD

The present disclosure is directed to the field of bolt fasteners. More specifically, the present disclosure is directed to a T-bolt fastening system for effectively and efficiently fastening together joining members when forming a structure.

### BACKGROUND

Building heavy duty construction frames from pre-cut framing members is highly desirable in many applications such as data centers, plant rooms, waste transfer stations, pipework support, walkways, steps, etc. However, building construction frames on-site presents various challenges such as high cost and time required for installation. For example, welding is often desired for sufficient strength when connecting the framing members together, which adds additional expense and time. Similarly, it is typically difficult to customize or adjust an installation site when forming the construction frame using welded framing members. Other challenges include difficulty in obtaining proper leveling of the frame when joining the pre-cut framing members and/or subsequent movement/sliding after securing the framing members together, particularly when attempting to use bolted connections. Further, when bolted connections are used for joining the framing members, traditional screw systems require process alignment of holes disposed in the framing members. Each of these difficulties are enhanced when one is trying to build the construction frame in challenging installation situations and environments.

What is needed therefore is a fastening system for quickly and efficiently joining two or more framing/joining members together. The fastening system would advantageously provide a strong bolted connection for avoiding the need for welding while preventing subsequent movement and sliding of the joined members after being fastened together.

### SUMMARY

The above and other needs are met by a fastening system for fastening a first joining member having a first slot to a second joining member having a second slot. The fastening system includes a T-bolt, a nut, and a washer. The T-bolt has a distal end and a proximal end and includes a bolt head disposed adjacent the distal end. The bolt head includes a bolt head base portion and a bolt head collar portion. The bolt head base portion includes an outer end and an interior end with the bolt head collar portion extending from the interior end of the bolt head base portion in a direction opposite the outer end of the bolt head base portion. The T-bolt further includes a shaft extending from the bolt head to the proximal end, the shaft including threads disposed along at least a portion of a length of the shaft. The nut includes a threaded opening for engaging the corresponding threads of the shaft. The washer includes a washer base portion and an aperture extending through the washer base portion for slidably positioning the washer around the shaft of the T-bolt between the nut and the bolt head. The washer base portion includes an outer end and an interior end having a washer engaging surface with the washer engaging surface including a plurality of concentric rings disposed around the aperture. When the fastening system is in an installed position for fastening the first joining member to the second joining member with the first and second slots being aligned, the T-bolt is dimensioned and configured such that the interior end of the bolt head base portion engages an outer surface of the first joining member, the bolt head collar portion extends at least partially into an opening formed by the aligned first and second slots, and the washer engaging surface engages an outer surface of the second joining member.

According to certain embodiments, the bolt head is dimensioned and configured to pass through the opening formed by the aligned first and second slots in a first orientation and is dimensioned and configured to prevent withdrawal of the bolt head back through the opening formed by the aligned first and second slots in a second orientation in which the T-bolt is rotated as compared to the first orientation. In some embodiments, the bolt head collar portion includes a front end, a rear end, a first side, and a second side with the first side and the second side each including a rounded portion and a planar portion. The rounded portion is dimensioned and configured to assist in rotation in the opening formed by the aligned first and second slots from the first orientation to the second orientation. The planar portion is dimensioned and configured to abut opposing interior walls of the aligned first and second slots in the second orientation.

According to certain embodiments, the interior end of the bolt head base portion includes a bolt head engaging surface having a plurality of teeth for enhancing the engagement to the outer surface of the first joining member. According to some embodiments, the plurality of teeth includes a plurality of parallel ribs extending from a first side of the bolt head engaging surface to a second side of the bolt head engaging surface with the bolt head collar portion disposed between the first side and the second side of the bolt head engaging surface.

According to certain embodiments, the bolt head collar portion is dimensioned and configured such that, when the fastening system is in the installed position, the bolt head collar portion extends through the first slot and partially into the second slot. In some embodiments, the washer collar portion is dimensioned and configured such that, when the fastening system is in the installed position, the washer collar portion extends only partially into the second slot.

According to another embodiment of the disclosure, a fastening system is provided for fastening a first joining member having a first slot to a second joining member having a second slot. The fastening system includes a T-bolt, a nut, and a washer. The T-bolt has a distal end and a proximal end and includes a bolt head disposed adjacent the distal end. The bolt head includes a bolt head base portion and a bolt head collar portion. The bolt head base portion includes an outer end and an interior end with the interior end of the bolt head including a bolt head engaging surface formed of a plurality of teeth. A bolt head collar portion extends from the interior end of the bolt head base portion in a direction opposite the outer end of the bolt head base portion with the bolt head engaging surface disposed around a base of the bolt head collar portion. The T-bolt further includes a shaft extending from the bolt head to the proximal end with threads disposed along at least a portion of a length of the shaft. The nut includes a threaded opening for engaging the corresponding threads of the shaft. The washer includes a washer base portion, an aperture extending through the washer base portion for slidably positioning the washer around the shaft of the T-bolt between the nut and the bolt head, and a washer engaging surface having a plurality of engaging members disposed on an interior end of the washer base portion around the aperture. When the fastening system is in an installed position for fastening the first joining member to the second joining member with the first and second slots being aligned, the T-bolt is dimensioned and configured such that the bolt head engaging surface of the bolt head base portion engages an outer surface of the first joining member, the bolt head collar portion extends at least partially into an opening formed by the aligned first and second slots, and the plurality of engaging members of the washer engaging surface engages an outer surface of the second joining member.

According to certain embodiments, the bolt head is dimensioned and configured to pass through the opening formed by the aligned first and second slots in a first orientation and is dimensioned and configured to prevent withdrawal of the bolt head back through the opening formed by the aligned first and second slots in a second orientation in which the T-bolt is rotated as compared to the first orientation. According to some embodiments, the bolt head collar portion includes a front end, a rear end, a first side, and a second side with the first side and the second side each including a rounded portion and a planar portion. The rounded portion is dimensioned and configured to assist in rotation in the opening formed by the aligned first and second slots from the first orientation to the second orientation. The planar portion is dimensioned and configured to abut opposing interior walls of the aligned first and second slots in the second orientation.

According to certain embodiments, the plurality of teeth of the bolt head engaging surface include a plurality of ribs disposed around the bolt head collar portion and the plurality of engaging members of the washer engaging surface includes a plurality of concentric rings disposed around the aperture of the washer.

According to certain embodiments, the bolt head collar portion is dimensioned and configured such that, when the fastening system is in the installed position, the bolt head collar portion extends through the first slot and partially into the second slot.

According to another embodiment of the disclosure, a washer for a fastening system includes a washer base portion, an aperture extending through the washer base portion, and a plurality of concentric rings disposed around the aperture.

### BRIEF DESCRIPTION OF THE DRAWINGS

Other embodiments of the disclosure will become apparent by reference to the detailed description in conjunction with the figures, wherein elements are not necessarily to scale so as to more clearly show the details, and wherein like reference numbers indicate like elements throughout the several views, and wherein:

FIG. 1 depicts an exploded front perspective view of a fastening system according to one embodiment of the present disclosure.

FIG. 2 depicts a front perspective view of the fastening system of FIG. 1.

FIG. 3 depicts a front view of the fastening system of FIGS. 1-2.

FIG. 4 depicts a side view of the fastening system of FIGS. 1-3.

FIGS. 5-6 depict additional front perspective views of the fastening system of FIGS. 1-4 for viewing the bolt head collar portion of the fastening system according to one embodiment of the present disclosure.

FIG. 7 depicts a cross-sectional view of a fastening system fastening two joining members together according to one embodiment of the present disclosure.

FIG. 8 depicts an exploded perspective view of a fastening system according to a second embodiment of the present disclosure.

FIG. 9 depicts a perspective view of the fastening system of FIG. 8.

FIG. 10 depicts a front view of the fastening system of FIGS. 8-9

FIG. 11 depicts a side view of the fastening system of FIGS. 8-10.

FIGS. 12-13 depict additional perspective views of the fastening system of FIGS. 8-11 for viewing the bolt head portion of the fastening system according to one embodiment of the present disclosure.

### DETAILED DESCRIPTION

The following description of preferred embodiments for this disclosure is presented for purposes of illustration and description. It is not intended to be exhaustive or to limit the disclosure to the precise form disclosed. Obvious modifications or variations are possible in light of the following teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the invention as determined by the appended claims when interpreted in accordance with the breadth to which they are fairly, legally, and equitably entitled.

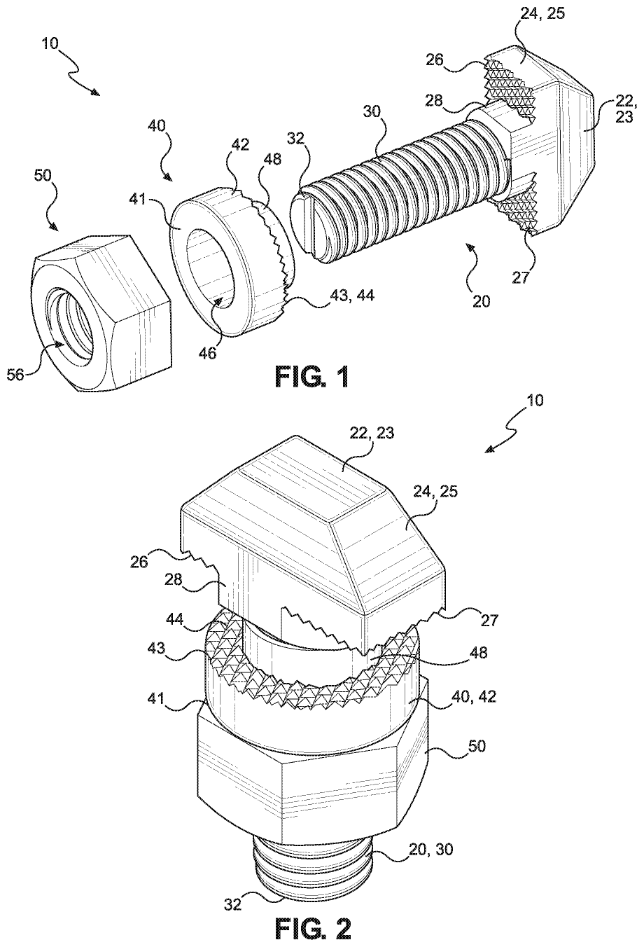

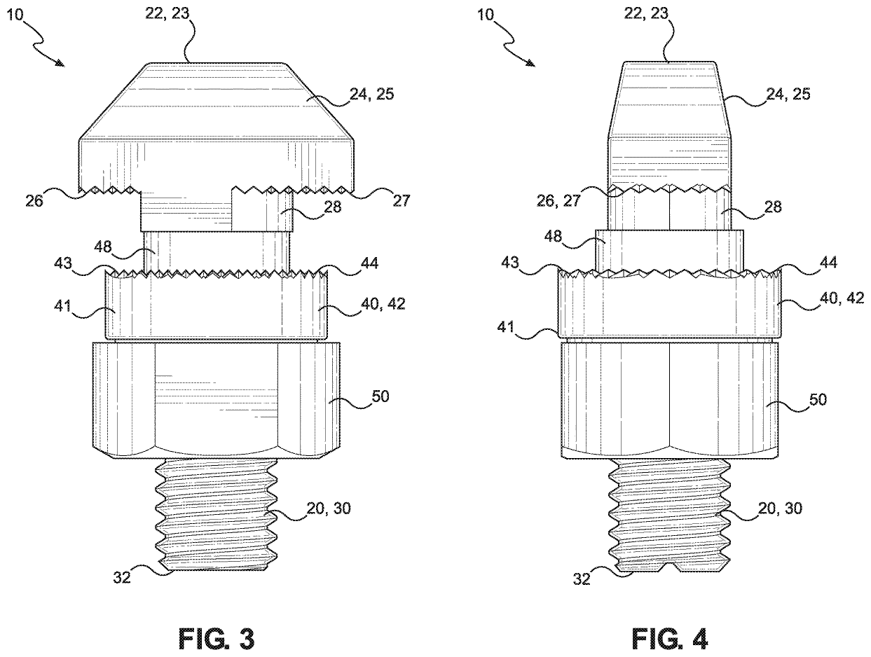

With reference to FIGS. 1-4, a first embodiment of a fastening system 10 according to the present disclosure is depicted. The fastening system 10 generally includes a T-bolt 20 having a bolt head 24 and shaft 30, a washer 40, and a nut 50. During installation, and as described in further detail below, the fastening system 10 is operable to fasten two joining members together when forming a structure by first passing the bolt head 24 through aligned slots of the two joining members. The T-bolt 20 is then rotated such that the bolt head 24 is prevented from being withdrawn from the aligned slots. With the T-bolt 20 rotated, the washer 40 is slid onto/along the shaft 30 of the T-bolt 20 and then the nut 50 is screwed onto the shaft 30 to press the two joining members of the structure between the bolt head 24 and the washer 40. For purposes of the present disclosure, the aligned slots of the two joining members refers to respective openings in the joining members being aligned in a manner such that the joining members may be joined together by installing the fastening system 10 using the aligned slots as described herein. The openings may take different forms and shapes but are typically elongated with the width of the openings being sized based on the respective sizes of the collar portions of the fastening system 10 components described below. Elongated slots allow for flexibility during installation (e.g., precise alignment not required) and easy adjustments in positioning of the joining members based on the structure being formed and the installation situations encountered by the installers.

As shown, the T-bolt 20 includes a distal end 22 and a proximal end 32. The bolt head 24 is positioned adjacent the distal end 22 of the T-bolt 20. The shaft 30 extends from the bolt head 24 to the proximal end 32 of the T-bolt 20. The T-bolt 20 is referred to as a “T-bolt” because the bolt head 24 and shaft 30 generally form a “T-shaped” bolt. The T-bolt is also referred to in the art as a hammer-head bolt. For purposes of the present disclosure, “T-bolt” will be used for consistency herein and refers to a bolt having a bolt head 24 that is dimensioned and configured as described above to (1) slide through aligned slots of at least two joining members that are intended to be connected by the fastening system 10 when forming a structure; and (2) prevent withdrawal of the bolt head 24 back through the aligned slots when the T-bolt 20 is rotated after the head 24 is passed through the aligned slots. In certain embodiments, the T-bolt may also be initially inserted into the aligned slots at its proximal end 32 and installed in a similar manner as described herein where the bolt head 24 is dimensioned and configured to prevent the T-bolt from being able to pass entirely through the aligned slots at least when the bolt head 24 is rotated into a desired installation position with respect to the opening of the aligned slots.

As shown, the bolt head 24 includes a base portion 25 having an outer end 23 and an interior end 27. The interior end 27 includes a bolt head engaging surface 26 for engaging an outer surface of a first joining member that the base portion 25 of the bolt head 24 is pressed against upon installation of the fastening system 10. In preferred embodiments, the bolt head engaging surface 26 includes a plurality of serrations, knurls, projections, teeth, etc. (hereinafter referred to as “teeth” for consistency) as shown for enhancing the gripping force between the bolt head engaging surface 26 and the outer surface of the first joining member. In preferred embodiments, the bolt head 24 further includes a bolt head collar portion 28 extending from the interior end 27 of the base portion 25 in a direction opposite the outer end 23. The collar portion 28 is dimensioned and configured to be positioned at least partially within the opening formed by the aligned slots upon installation of the fastening system 10 with respect to the joining members. In most preferred embodiments, the plurality of teeth of the bolt head engaging surface 26 cover substantially the entirety of the interior end 27 of the base portion 25, including particularly the entirety of the area around the interior end 27 of the base portion 25 from which the collar portion 28 extends (i.e., the plurality of teeth of the bolt head engaging surface 26 are disposed around the base of the collar portion 28).

With continued reference to FIGS. 1-4, the washer 40 includes a base portion 42 having an outer end 41 and an interior end 43. The interior end 43 includes a washer engaging surface 44. Referring to FIG. 1, an aperture 46 extends from the outer end 41 through the interior end 43. The aperture 46 is dimensioned and configured such that the washer 40 is able to be slidably positioned around the shaft 30 of the T-bolt 20 between the bolt head 24 and nut 50 during installation of the fastening system 10. In preferred embodiments, and like the bolt head engaging surface 26 of the bolt head 24, the washer engaging surface 44 includes a plurality of teeth for enhancing the gripping force between the washer engaging surface 44 and an outer surface of a second joining member that the base portion 42 of washer 40 is pressed against upon installation of the fastening system 10. In preferred embodiments, and also similar to bolt head 24 as described above, the washer 40 further includes a washer collar portion 48 extending from the interior end 43 of the base portion 42 in a direction opposite the outer end 41. The collar portion 48 is dimensioned and configured to be positioned at least partially within the opening formed by the aligned slots (i.e., on the opposite side of the aligned slots as compared to the bolt head collar 28) upon installation of the fastening system 10 with respect to the joining members.

In embodiments in which the washer 40 includes the collar portion 48, the aperture 46 also extends through the collar portion 48 such that the base portion 42 and collar portion 48 are slidably positioned together around the shaft 30 of the T-bolt 20 during installation of the fastening system 10. In preferred embodiments, the plurality of teeth of the washer engaging surface 44 cover substantially the entirety of the interior end 43 of the base portion 42, including particularly the entirety of the area around the interior end 43 of the base portion 42 from which the collar portion 48 extends (i.e., the plurality of teeth of the washer engaging surface 44 are disposed around the base of the collar portion 48).

In preferred embodiments, the washer 40 is formed as a unitary structure containing both the base portion 42 and collar portion 48. Also, in preferred embodiments, the collar portion 48 is in the form of a cylindrical ring formed around the aperture 46. However, other embodiments of the washer 40 are contemplated as being within the scope of the present disclosure including the collar portion 48 having a separate sleeve type arrangement that is pressed against or within the base portion 42 of the washer 40 during installation. The collar portion 48 could also be segmented or have a more squared shape similar to the bolt head collar portion 28 instead of the continuous ring shown in the present figures.

With reference back to FIG. 1, the shaft 30 of the T-bolt 20 extends from the bolt head collar portion 28 to the proximal end 32 of the T-bolt 20. The shaft 30 is threaded along at least a portion of its length for engaging corresponding threads of a threaded opening 56 of the nut 50. When joining the joining members, the bolt head 24 is inserted into the aligned slots of the joining members and then rotated to prevent withdrawal. The washer 40 is dimensioned and configured to then be slidably positioned around the shaft 30 on the opposite side of the joining members as compared to the bolt head 24. The nut is then advanced along the threads of the shaft 30 of the T-bolt 20 to fasten the joining members together between the bolt head 24 and the washer 40/nut 50.

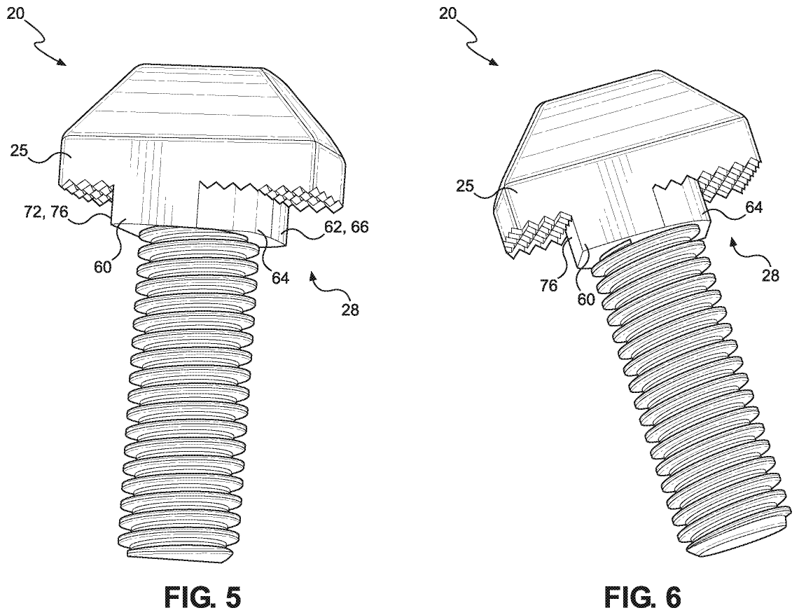

According to another aspect of the present disclosure, and with reference to FIGS. 5-6, the bolt head collar portion 28 includes a front end 60, a first side 62, a rear end (end opposite front end 60 but not shown in FIGS. 5-6), and second side 72. To clarify, rear end and second side 72 are the same as front end 60 and first side 62 when the T-bolt 20 is rotated to depict a rear view of the T-bolt 20 instead of the front views as shown in FIGS. 5 and 6. In preferred embodiments, the front end 60 and rear end are planar. As shown, the planar front end 60 transitions when moving in a counterclockwise direction with respect to FIGS. 5-6 to a rounded portion 64 of first side 62. Rounded portion 64 of first side 62 then transitions to a planar side portion 66. Planar side portion 66 then transitions to the planar rear end. From the planar rear end, the collar portion 28 transitions to a rounded portion (not shown) of second side 72 and then to a planar side portion 76 to complete the periphery of the bolt head collar portion 28.

In operation, the overall periphery of the bolt head collar portion 28 is dimensioned and configured to fit underneath the footprint of the base portion 25 such that the bolt head 24 is able to pass through the aligned slots of the joining members during installation as described above without interference from the bolt head collar portion 28. In preferred embodiments, the planar front end 60 and corresponding planar rear end of the bolt head collar portion 28 are generally aligned with the outermost extending portions of the corresponding front and rear ends of the base portion 25. The first side 62 and second side 72 are then dimensioned and configured such that (1) rounded portion 64 of first side 62 and corresponding rounded portion of second side 72 of the bolt head collar portion 28 permit/assist in rotation of the T-bolt 20 after being passed through the aligned slots (i.e., rounded portions of first side 62 and second side 72 serve as ramps to the planar side portions during rotation of the T-bolt in a counterclockwise direction); and (2) the planar side portion 66 of first side 62 and planar side portion 76 of second side 72 abut opposing interior walls of the aligned slots after rotation of the T-bolt 20. The close abutment of the planar side portions 66 and 76 of the first and second sides 62 and 72 is intended to prevent the T-bolt 20 from further spinning/rotating within the aligned slots when a user is tightening the nut 50 during installation of the fastening system 10.

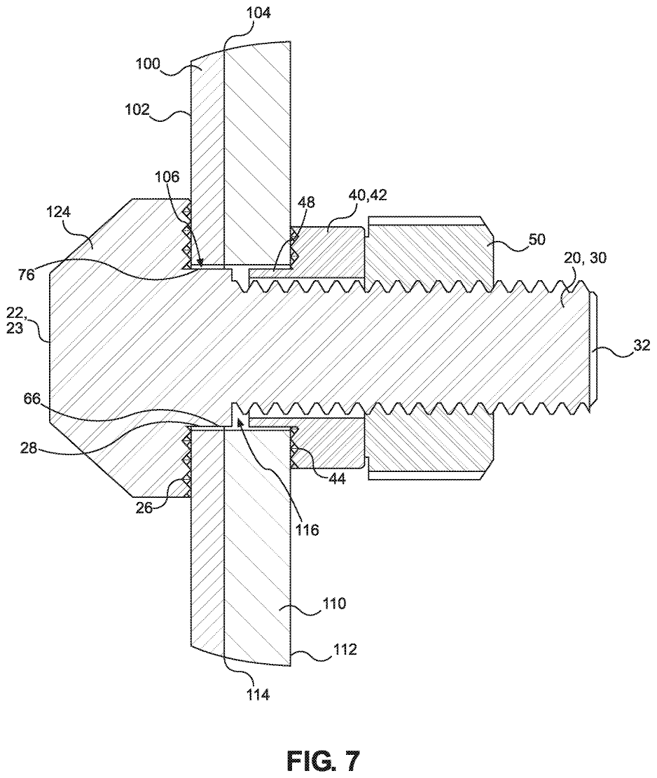

With reference to FIG. 7, a cross-sectional view of the fastening system 10 is depicted as installed with respect to a first joining member 100 and a second joining member 110. As shown, the first joining member 100 includes an outer surface 102 and an inner surface 104 with a slot 106 extending from the outer surface 102 through the inner surface 104. The second joining member then includes a corresponding outer surface 112 and an inner surface 114 with a slot 116 extending from the outer surface 112 through the inner surface 114. With the T-bolt 20 in the installed position with slots 106 and 116 aligned as shown in FIG. 7, the bolt head engaging surface 26 of the bolt head 24 engages the outer surface 102 of the first joining member 100 around slot 106 while the bolt head collar portion 28 is disposed at least partially within the opening formed by aligned slots 106 and 116. As shown, in certain embodiments, the bolt head collar portion 28 is dimensioned and configured with respect to the thickness of the first joining member 100 such that the bolt head collar portion 28 extends entirely through the first slot 106 and partially into the second slot 116. Further, and again as shown, the planar side portions 66, 76 of the bolt head collar portion 28 closely abut opposing interior walls of the slots 106 and 116 to prevent the T-bolt 20 from further spinning/rotating within the aligned slots 106 and 116 when a user is tightening the nut 50 during installation of the fastening system 10 as described above.

With respect to the washer 40 in the installed position as shown in FIG. 7, the washer engaging surface 44 of the base portion 42 of washer 40 engages the outer surface 112 of the second joining member 110 around slot 116 while the washer collar portion 48 is disposed at least partially within the opening formed by aligned slots 106 and 116. As noted above, bolt head collar portion 28 in certain embodiments is dimensioned and configured to extend entirely through the slot 106 and partially into the slot 116. According to this embodiment, the washer collar portion 48 would extend only partially within slot 116. However, the extent to which the collar portions 28 and 48 extend into the respective slots 106 and 116 of the opening formed by the aligned slots depends on both the dimensions of the collar portions 28, 48 as compared to the thickness of the first joining member 100 and second joining member 110.

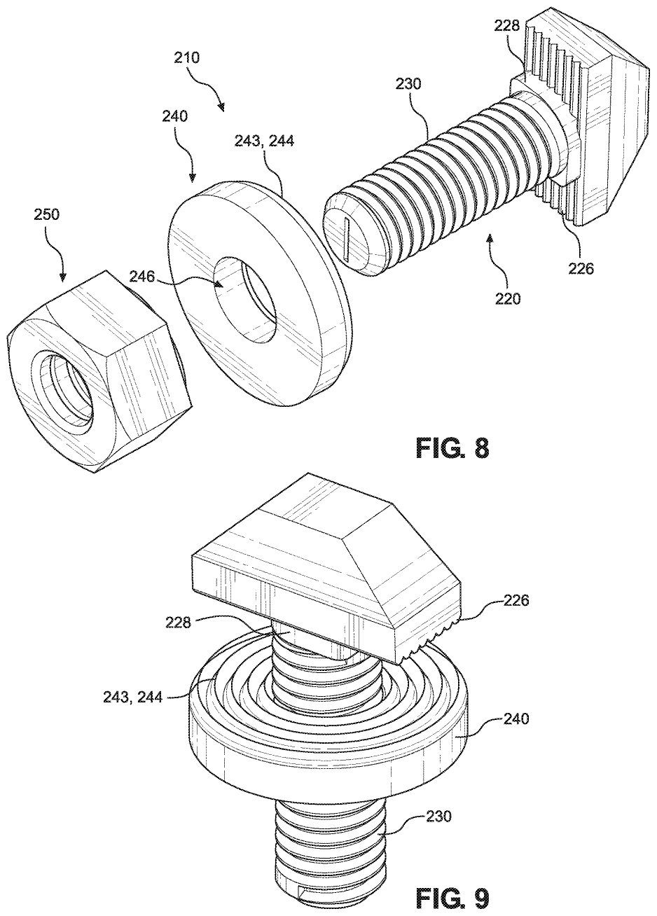

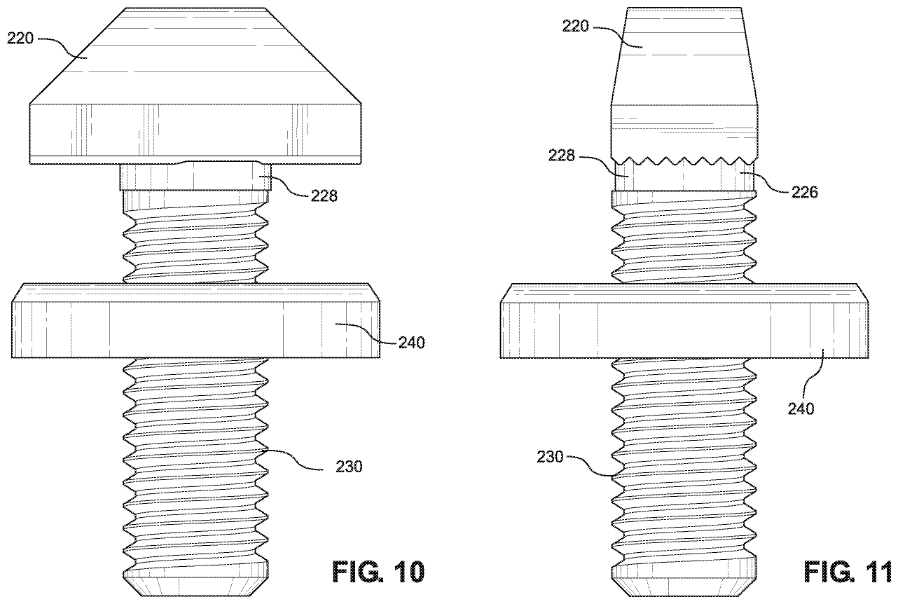

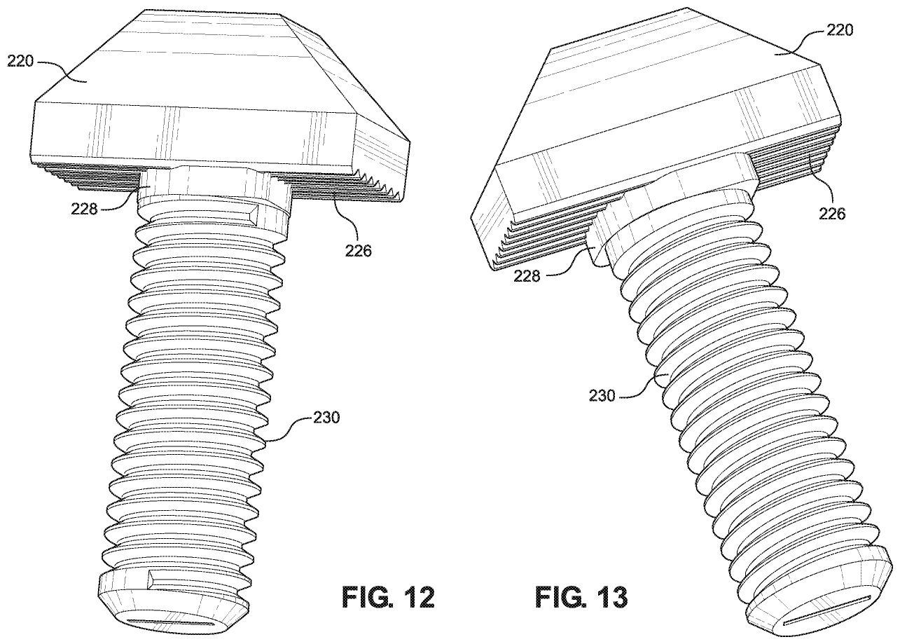

With reference to FIGS. 8-13, a fastening system 210 according to a second exemplary embodiment of the present disclosure is depicted. Similar to fastening system 10, fastening system 210 includes a T-bolt 220, a washer 240, and a nut 250. As compared to the embodiment of FIGS. 1-7, the teeth of the bolt head engaging surface 226 of this embodiment are in the form of a plurality of parallel ribbed lines extending from a first side of the bolt head engaging surface 226 to the second side of the bolt head engaging surface 226 with the bolt head collar portion 228 disposed therebetween. With respect to the washer 240 as compared to washer 40, the interior end 243 of washer 240 includes a washer engaging surface 244 in the form of a plurality of concentric rings disposed around the aperture 246 (and washer collar portion being omitted in this embodiment).

In operation, threaded shaft 230 of T-bolt 220 extends from the bolt head collar portion 228 for engaging corresponding threads of the nut 250 with the washer 240 disposed therebetween when joining two joining members in a similar manner as discussed above with respect to the embodiment of FIGS. 1-7. Thus, according to the installation position of this embodiment, the plurality of parallel ribbed lines of the bolt head engaging surface 226 are pressed against the outer surface of the first joining member while the concentric rings of the washer engaging surface 244 are pressed against the outer surface of the second joining member.

With respect to the concentric rings of the washer engaging surface 244 during the installation process, test results have found that the plurality of concentric rings of fastening system 210 provides enhanced gripping ability as compared to the embodiment of FIGS. 1-7. Without being bound by any particular theory, it is believed that the ends of the rings “bite” into the outer surface of the joining member it is pressed against without removing any material (or minimal material being removed) of the joining member or the washer engaging surface 244. In other words, the rings are pushed into the outer surface of the joining member such that the rings slightly deform the outer surface of the joining member in a manner that does not cut away the surface in which it is bearing against. Such a scenario enhances the friction between the two surfaces and prevents slipping between the two components following installation. Additionally, the concentric rings provide more surface area bearing against the outer surface of the joining member as compared to the plurality of small spikes of the washer engaging surface 44 of FIGS. 1-7. Given this enhanced gripping strength, washer 240 having a washer engaging surface 244 in the form of a plurality of concentric rings disposed around the aperture 246 of the washer 240 would be advantageously used in various other applications in addition to the T-bolt type fastening system disclosed herein.

In operation, the fastening systems 10, 210 of the present disclosure provide a quick and efficient installation process for securing the first joining member 100 to the second joining member 110. While the installation is process is quick and efficient even in challenging environments, the bolt head collar portion 28, 228 and washer collar portion 48, 248 provide a strong and secure bolted connection for preventing subsequent movement and sliding of the joining members after being fastened together. The teethed engaging surfaces 26, 226 and 44, 244 around the respective slots 106 and 116 further enhance the grip/connection of the fastening system 10, 210 with respect to the joining members.

It should be understood that the fastening system 10 may be used for joining any number of different types of members in which slots/apertures of the joining members are aligned when joining the members together. In certain embodiments, the joining members are different sized and configured framing members such as slotted framing posts and accompanying slotted brackets for forming customizable heavy duty construction frames for a wide variety of applications.

What is claimed is:

1. A fastening system for fastening a first joining member having a first slot to a second joining member having a second slot, the fastening system comprising:
a T-bolt having a distal end and a proximal end, the T-bolt including:
a bolt head disposed adjacent the distal end, the bolt head including a bolt head base portion and a bolt head collar portion, the bolt head base portion having an outer end and an interior end, the bolt head collar portion extending from the interior end of the bolt head base portion in a direction opposite the outer end of the bolt head base portion, and
a shaft extending from the bolt head to the proximal end, the shaft including threads disposed along at least a portion of a length of the shaft;
a nut having a threaded opening for engaging the corresponding threads of the shaft; and
a washer including a washer base portion and an aperture extending through the washer base portion for slidably positioning the washer around the shaft of the T-bolt between the nut and the bolt head, the washer base portion having an outer end and an interior end having a washer engaging surface, the washer engaging surface including a plurality of concentric rings disposed around the aperture,
wherein, when the fastening system is in an installed position for fastening the first joining member to the second joining member with the first and second slots being aligned, the T-bolt is dimensioned and configured such that the interior end of the bolt head base portion engages an outer surface of the first joining member, the bolt head collar portion extends at least partially into an opening formed by the aligned first and second slots, and the washer engaging surface engages an outer surface of the second joining member.

2. The fastening system of claim 1 wherein the bolt head is dimensioned and configured to pass through the opening formed by the aligned first and second slots in a first orientation and is dimensioned and configured to prevent withdrawal of the bolt head back through the opening formed by the aligned first and second slots in a second orientation in which the T-bolt is rotated as compared to the first orientation.

3. The fastening system of claim 2 wherein the bolt head collar portion includes a front end, a rear end, a first side, and a second side, the first side and the second side each including a rounded portion dimensioned and configured to assist in rotation in the opening formed by the aligned first and second slots from the first orientation to the second orientation and a planar portion dimensioned and configured to abut opposing interior walls of the aligned first and second slots in the second orientation.

4. The fastening system of claim 1 wherein the interior end of the bolt head base portion includes a bolt head engaging surface having a plurality of teeth for enhancing the engagement to the outer surface of the first joining member.

5. The fastening system of claim 4 wherein the plurality of teeth includes a plurality of parallel ribs extending from a first side of the bolt head engaging surface to a second side of the bolt head engaging surface with the bolt head collar portion disposed between the first side and the second side of the bolt head engaging surface.

6. The fastening system of claim 1 wherein the bolt head collar portion is dimensioned and configured such that, when the fastening system is in the installed position, the bolt head collar portion extends through the first slot and partially into the second slot.

7. The fastening system of claim 5 wherein the washer collar portion is dimensioned and configured such that, when the fastening system is in the installed position, the washer collar portion extends only partially into the second slot.

8. A fastening system for fastening a first joining member having a first slot to a second joining member having a second slot, the fastening system comprising:
a T-bolt having a distal end and a proximal end including, the T-bolt including:
a bolt head disposed adjacent the distal end and having a bolt head base portion and a bolt head collar portion, the bolt head base portion having an outer end and an interior end, the interior end of the bolt head including a bolt head engaging surface formed of a plurality of teeth, and the bolt head collar portion extending from the interior end of the bolt head base portion in a direction opposite the outer end of the bolt head base portion with the bolt head engaging surface disposed around a base of the bolt head collar portion, and
a shaft extending from the bolt head to the proximal end, the shaft including threads disposed along at least a portion of a length of the shaft;
a nut having a threaded opening for engaging the corresponding threads of the shaft; and
a washer including a washer base portion, an aperture extending through the washer base portion for slidably positioning the washer around the shaft of the T-bolt between the nut and the bolt head, and a washer engaging surface having a plurality of engaging members disposed on an interior end of the washer base portion around the aperture,
wherein, when the fastening system is in an installed position for fastening the first joining member to the second joining member with the first and second slots being aligned, the T-bolt is dimensioned and configured such that the bolt head engaging surface of the bolt head base portion engages an outer surface of the first joining member, the bolt head collar portion extends at least partially into an opening formed by the aligned first and second slots, and the plurality of engaging members of the washer engaging surface engages an outer surface of the second joining member.

9. The fastening system of claim 8 wherein the bolt head is dimensioned and configured to pass through the opening formed by the aligned first and second slots in a first orientation and is dimensioned and configured to prevent withdrawal of the bolt head back through the opening formed by the aligned first and second slots in a second orientation in which the T-bolt is rotated as compared to the first orientation.

10. The fastening system of claim 9 wherein the bolt head collar portion includes a front end, a rear end, a first side, and a second side, the first side and the second side each including a rounded portion dimensioned and configured to assist in rotation in the opening formed by the aligned first and second slots from the first orientation to the second orientation and a planar portion dimensioned and configured to abut opposing interior walls of the aligned first and second slots in the second orientation.

11. The fastening system of claim 8 wherein the plurality of teeth of the bolt head engaging surface include a plurality of ribs disposed around the bolt head collar portion and the plurality of engaging members of the washer engaging surface includes a plurality of concentric rings disposed around the aperture of the washer.

12. The fastening system of claim 8 wherein the bolt head collar portion is dimensioned and configured such that, when the fastening system is in the installed position, the bolt head collar portion extends through the first slot and partially into the second slot.

13. A washer for a fastening system, the washer including a washer base portion, an aperture extending through the washer base portion, and a plurality of concentric rings disposed around the aperture.
